(19) United States
(12) Patent Application Publication
(10) Pub. No.: US 2024/0314081 A1
(43) Pub. Date: Sep. 19, 2024

(54) LEARNING-BASED DATA COMPRESSION METHOD AND SYSTEM FOR INTER-SYSTEM OR INTER-COMPONENT COMMUNICATIONS

(71) Applicant: Intel Corporation, Santa Clara, CA (US)

(72) Inventors: Wenjie WANG, Shanghai (CN); Yi ZHANG, Shanghai (CN); Junjie LI, Shanghai (CN); Yi QIAN, Shanghai (CN); Wanglei SHEN, Shanghai (CN); Lingyun ZHU, Shanghai (CN)

(73) Assignee: Intel Corporation, Santa Clara, CA (US)

(21) Appl. No.: 18/574,809

(22) PCT Filed: Nov. 24, 2021
(86) PCT No.: PCT/CN2021/132713

§ 371 Date: Dec. 28, 2023

(51) Int. Cl. H04L 47/2441; H04L 47/38

(52) U.S. Cl. CPC H04L 47/2441; H04L 47/38

(57) ABSTRACT

Systems, apparatuses and methods include technology that identifies data that is to be transferred from a first device to a second device. The technology classifies the data into a category from a plurality of categories, selects a compression scheme from a plurality of compression schemes based on the category and compresses the data based on the compression scheme.

### TECHNICAL FIELD

Embodiments generally relate to data compression and decompression. More particularly, embodiments implement a scheme to sample and learn the traffic patterns for cross-device and cross-component communication, and activate the compression when traffic begins to reach hardware limits.

### BACKGROUND

Data communication across system sub-components or across different devices may be fundamental to system level performance. As processes continue to grow and become more data heavy, data communication correspondingly begins to increase. For example, the rapid growth of processing power in deep-learning specific accelerator silicon may require faster data throughput to fully leverage the capability of such devices. It may be found that high-speed input/output (IO) to these devices may effectively cause bottlenecks in communication, thus resulting in lower system-level performance that incurs higher latency operations. Similar situations occur for all cross-device or cross-component communications.

### BRIEF DESCRIPTION OF THE DRAWINGS

The various advantages of the embodiments will become apparent to one skilled in the art by reading the following specification and appended claims, and by referencing the following drawings, in which:

FIG. 1 is a diagram of an example of a compression and decompression architecture according to an embodiment;

FIG. 2 is a flowchart of an example of a method to implement a compression scheme according to an embodiment;

FIG. 3 is a diagram of an example of a packet classification architecture according to an embodiment;

FIG. 4 is a flowchart of an example of a method of compressing data according to an embodiment;

FIG. 5 is a flowchart of an example of a method to decompress data according to an embodiment;

FIG. 6 is a diagram of an example of a compression/decompression table according to an embodiment;

FIG. 7 is a block diagram of an example of performance-enhanced computing system according to an embodiment;

FIG. 8 is an illustration of an example of a semiconductor apparatus according to an embodiment;

FIG. 9 is a block diagram of an example of a processor according to an embodiment; and

FIG. 10 is a block diagram of an example of a multi-processor based computing system according to an embodiment.

### DESCRIPTION OF EMBODIMENTS

Embodiments as described herein effectively compress data (e.g., video data, text data, audio data, artificial intelligence related data, deep learning data, neural network based data, etc.) based on task based (e.g., application based) analysis. For example, the data communication between hardware elements (e.g., host central processing unit and an accelerator devices) may be motivated by task based analysis. The tasks have unique patterns and data signatures, such as the inference, data transfer, network transfer, or result transfer tasks. Effective data compression algorithms may be applied to reduce bandwidth requirements in response to hardware limits (e.g., bandwidth) being reached.

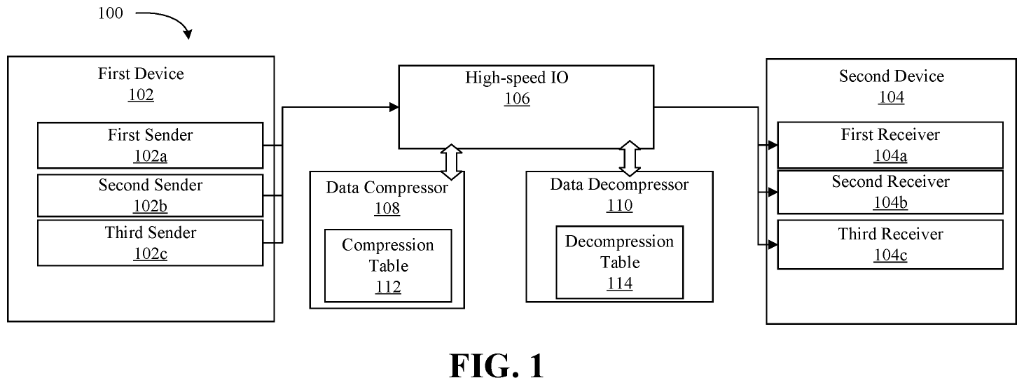

FIG. 1 illustrates a compression and decompression architecture 100 that facilitates low latency and low bandwidth communication between a first device 102 (e.g., a host processor, a first server, etc.) and a second device 104 (e.g., a second server, an accelerator, vision processing unit, graphics processor, etc.). In detail, the first device 102 may offload operations to the second device 104. For example, the second device 104 may be more efficient at executing the operations than the first device 102. In order to execute the operations, the first device 102 may transmit data to the second device 104. As the volume of data increases, latency may be increased if the high-speed input/output (IO) 106 (e.g., a network connection, Peripheral Component Interconnect Express connection, bus, etc.) is unable to transport all the data in an efficient manner due to physical constraints such as bandwidth. Other types of bottlenecks may occur in the high-speed IO 106 causing the second device 104 to be underutilized and wait for data from the first device 102.

Thus, the compression and decompression architecture 100 includes a scheme to sample and learn the traffic patterns for cross-device communications, such as between first device 102 and second device 104. The compression and decompression architecture 100 may activate the compression when network traffic begins to hit a hardware limit of high-speed IO 106. That is, the high-speed IO 106 may have a certain bandwidth that cannot be exceeded. When the bandwidth is being reached, the compression and decompression architecture 100 may convert from a normal (uncompressed) scheme to a compression and decompression scheme. Doing so may reduce computing resources without reducing throughput. For example, compression and decompression may not be necessary until a hardware limit is reached. Furthermore, unnecessary compression and decompression may needlessly consume power and compute resources. Thus, compression and decompression are not implemented until a hardware limit is reached and throughput may be slowed due to data waiting and high data transfer latency of uncompressed data. After the hardware limit is reached, the compression and decompression are implemented to maintain throughput and efficiency while remaining under hardware limitations (e.g., bandwidth).

The compression and decompression architecture 100 includes a data compressor 108 and data decompressor 110 on high-speed IO 106. The data compressor 108, the data decompressor 110 and the high-speed IO 106 may form a communication path between the first device 102 and the second device 104.

Initially, the data compressor 108 may categorize data into a category to compress the data. For example, the data compressor 108 may first train learning models by using the data either online (e.g., with labeled data) or through an offline process with labels with Hidden Markov Models (HMMs). For training the learning models online, labeled data may be provided to the data compressor 108 which then learns the best algorithms to utilize to satisfy the various requirements of the data type (e.g., latency and compression ratio).

In some embodiments, the data compressor 108 may be trained offline. For example, offline training may include gathering a volume of labeled data that is then provided to the data compressor 108 to train the data compressor 108 to categorize the data (e.g., with the HMMs) into a category from a plurality of categories and learn the best algorithms to satisfy the various requirements of the category. For example, if the various requirements (e.g., latency and compression ratios) are not being met, the data compressor 108 may select different algorithms for the category until the various requirements are met. The association of the different algorithms with the data types may be stored together in the compression table 112. In some examples, if all of the various requirements cannot be met, the data compressor 108 will choose to meet the highest priority requirements while bypassing meeting the lowest priority requirements to achieve a best possible result.

Thus, the HMMs may be trained to classify data. Therefore, the HMMs may classify data, and the data compressor 108 collects the data compression ratio of different algorithms on each pattern (e.g., category). Once compression is activated, the data compressor 108 may send a notification to the data decompressor 110 (e.g., a recipient) that compression is activated, and begin to include a compression header to the data packets with a chosen compression algorithm for each category of data. The compression will stop if communication levels drop below the hardware limit.

Thus, the data compressor 108 includes a plurality of HMMs that may classify data. The data compressor 108 includes a compression table 112. The compression table 112 may map data types (e.g., categories) to specific compression formats. Thus, the HMMs may classify the data into a category (e.g., a data type), and the data compressor 108 may reference the compression table 112 to determine a corresponding compression format associated with the data type.

Notably, the compression table 112 may be generated prior to compression activation. For example, the data compressor 108 and/or data decompressor 110 may collect the data compression ratio of different algorithms on each category. In some embodiments, the data compressor 108 may update the compression table 112 during live usage and based on metrics generated while compression is activated to compress data. For example, the data compressor 108 and/or data decompressor 110 may track whether the latency and compression ratio parameters are being satisfied by the compression algorithms, and update the algorithms if not.

For example, a first algorithm may initially be used to compress video data. As video data evolves, the first algorithm may become less effective thus leading to higher latency and worst compression ratios, leading to a failure to meet the latency parameter and the compression ratio parameter for video content. The data compressor 108 and/or data decompressor 110 may identify such a failure, and implement new algorithms to meet the compression ratio parameter and latency parameter. Once a new algorithm is identified as meeting the compression ratio parameter and the latency parameter, the data compressor 108 may store the new algorithm in association with the video category to use the new algorithm to compress video data.

The compression table 112 may be generated during training of the HMMs to identify best algorithms to be used for various data types. For example, an algorithm may be selected to provide the best compression ratio for the data transferred while still meeting the latency parameter (e.g., data must be provided in under a certain amount of time). That is the compression and decompression architecture 100 may leverage the computation capability of hardware and is not limited by data transfer bandwidth. Some embodiments may operate with an AI based accelerator card where the computation workload of the accelerator is specific, and the computation capability is very high.

The decompression table 114 corresponds to the compression table 112. The data decompressor 110 may receive the compression table 112 and the data from the data compressor 108 via the high-speed IO 106. The data decompressor 110 may then identify a header in the data. The header may indicate a data type of the data. The data decompressor 110 may store the compression table 112 as the decompression table 114, and refence the decompression table 114 to identify an algorithm that was used to compress the data. The data decompressor 110 may then decompress the data based on the identified algorithm. The decompressed data may then be provided to one of the first, second and third receivers 104a, 104b, 104c.

The traffic across the high-speed IO 106 may be binary data that is a series of packets. Different applications produce different data traffic which may be treated as being generated by certain stochastic process. Therefore, embodiments include an HMM based algorithm for data type classification. The data flow is characterized by a time series of packet size X, which is analyzed by the HMM. For example, a series of data packets is sequential data that could be modelled as a state chain where each timepoint has a state, where together the timepoints form a state chain. An HMM is suitable for analyzing such kinds of sequential data (e.g., speech data and hand-written data). Thus, some embodiments may use the HMM to characterize the packet size sequence and model its state chain probability distribution. Then, given a series of packets, some embodiments calculate the posterior probabilities from different application HMM models and determine the application type by the highest probability. Thus, the HMM will use the time series of packet size X as an input to the HMM, and output the probability distribution of a next application type. Since embodiments first collect the training data packets either offline or online (with labels), including data samples from different data type, then each data type is modelled by HMM p(X, Z|θ) as shown in Equation 1 below:

$$p ( X , Z \vert θ ) = p ( {z}_{1} \vert π ) [ {\prod }_{n = 2}^{N} p ( {z}_{n} \vert {z}_{n - 1} , A ) ] {\prod }_{m = 1}^{N} p ( {x}_{m} \vert {z}_{m} , ϕ ) \qquad Equation 1$$

In Equation 1, X={x₁, . . . , x_{N}} contains packet sizes of a series of packets with different sizes xᵢ, Z={z₁, . . . , z_{N}} represents the application type (e.g., hidden states) and θ={π, A, ϕ} denotes the set of parameters. For example, A may be a transition matrix that models the transition probability among different Z, π may be the probability of the different hidden states, and ϕ may be a parameter matrix to compute xₘ probability distribution when an actual output is zₘ. Then the probability that the packet series is generated by certain application HMM is given by certain application HMM is given by Equation 2:

$${p}_{i} ( X \vert Z , θ ) \qquad Equation 2$$

Therefore, some embodiments determine the data type by finding the HMM i with max posterior probability by Equation 3:

$$Arg {max}_{i} {p}_{i} ( X \vert Z , θ ) \qquad Equation 3$$

Thus, an HMM (which corresponds to a category) that classifies the data and has a highest probability of being correct is selected, and the category associated is selected for the data. With the data pattern analyzed, the data compressor 108 categorizes the data packets based on a data signature of the data. The data signature may be a packet signature digest, such as an identification and/or model identification calculated by the HMM model described above, or simply packet size distribution or the first K bytes, to index the best compression algorithm suitable. The algorithm index is encoded into the packets so that the data decompressor 110 may decompress the packets accordingly and with reference to the decompression table 114.

The data compressor 108 selects the best compression algorithm based on a desired compression ratio and desired latency. The set of compression algorithms set are pre-selected to cover different traffic types, include Lempel-Ziv-Welch (LZW), arithmetic coding, and other compression schemes such as Base Delta. Different compression algorithms have different advantages and drawbacks. For example, some compression algorithms may be efficient at compression ratios, while other compression algorithms may be speed efficient. Notably, most compression algorithms may not handle all aspects, and different applications demand different features with efficiency. For example, for real-time video analysis, the speed of compression (e.g., latency parameter is low) and decompression is important to avoid high latency processes that may interrupt streaming of the video. In contrast, for large plain text, the compress-ratio (the compress-ratio is set to high) is important rather than the speed (e.g., a latency parameter is set to high). Thus, different compression algorithms may be selected for video data and text data. As such, different compression algorithms are used for different data types to maintain a compression ratio and latency that comports with the data type.

To select a proper compression algorithm, embodiments include a measurement-based selection for different applications. The following equation 4 may be used to measure the performance of compression algorithm

$$TotalCost = {T}_{compression} + {T}_{decompression} + \frac{AveragePackaetSize}{PcieSpeed} \qquad Equation 4$$

Embodiments may first calculate the TotalCost of different compression algorithms for different data types based on historical data. During runtime (e.g., during processing of data), the data compressor 108 selects a compression algorithm based with minimum TotalCost for the data type derived from the HMM. In Equation 1, T_{compression} is the compression time using a specified compression algorithm, T_{decompression} is the decompression time using a certain compression algorithm and

$$\frac{AveragePackaetSize}{PcieSpeed}$$

is the time for Peripheral Component Interconnect Express (PCIE) transmission.

Notably, different compression algorithms may be used simultaneously. For example suppose a first sender 102a is a video application that has a latency parameter corresponding to a low latency and a compression ratio parameter corresponding to a low compression ratio. The data compressor 108 may compress data from the first sender 102a to select a low-latency, low compression ratio compression algorithm. Suppose a second sender 102b is a text application that has a latency parameter corresponding to a high latency and a compression ratio parameter corresponding to a high compression ratio. The data compressor 108 may compress data from the second sender 102b to select a high-latency, high compression ratio compression algorithm. Similarly, the data compressor 108 may compress data from a third sender 102c to select a medium-latency, medium compression ratio compression algorithm. In some embodiments, the data compressor 108 and data decompressor 110 may actively adjust the compression algorithms based on an artificial intelligence learning process that is executed.

Thus, the compression and decompression architecture 100 may efficiently transmit data over the high-speed IO 106. Furthermore, the compression and decompression architecture 100 may select appropriate compression algorithms for various data types to avoid negatively impacting performance.

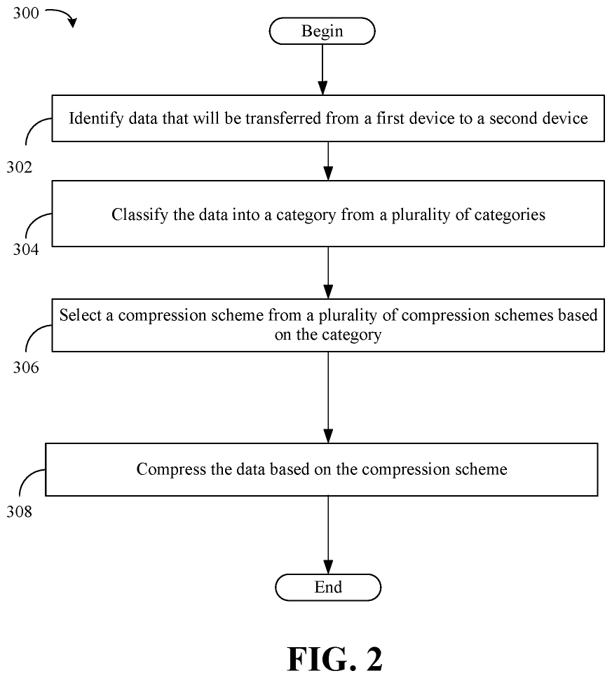

FIG. 2 shows a method 300 to implement a compression scheme. The method 300 may be readily combinable with any of the embodiments described herein. For example, the method 300 may implement and/or operate in conjunction with one or more aspects of the compression and decompression architecture 100 (FIG. 1) already discussed. In an embodiment, the method 300 is implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 300 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 302 identifies data that will be transferred from a first device to a second device. Illustrated processing block 304 classifies the data into a category from a plurality of categories. Illustrated processing block 306 selects a compression scheme from a plurality of compression schemes based on the category. Illustrated processing block 308 compresses the data based on the compression scheme.

In some embodiments, the method 300 selects the compression scheme based on a compression ratio parameter and a latency parameter associated with the category. In some embodiments, the method 300 further includes determining that a hardware limit been reached, and determining that the data will be compressed based on the hardware limit being reached. In some embodiments, the method 300 further includes classifying the data into the category with a Hidden Markov Model. In some embodiments, the method 300 further includes classifying the data into the category based on one or more of a packet size distribution associated with the data or a subset of bytes of the data. In some embodiments, the method 300 further includes selecting the compression scheme based on a map of the plurality of categories to compression schemes.

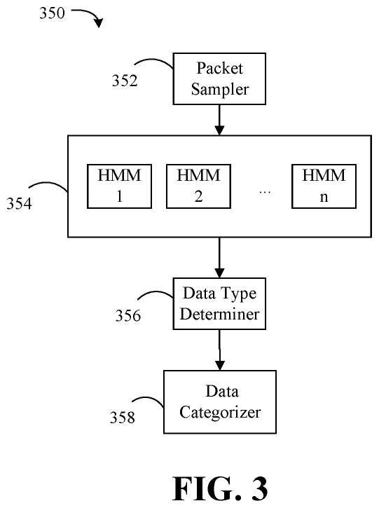

FIG. 3 illustrates an architecture 350 for packet classification that may be trained for example with a Viterbi algorithm & Baum-Welch algorithm. For example, the architecture 350 may implement and/or operate in conjunction with one or more aspects of the compression and decompression architecture 100 (FIG. 1) and/or the method 300 (FIG. 2), already discussed. The architecture 350 may correspond to the data compressor 108 (FIG. 1). The packet sampler 352 may sample and learn the traffic pattern between the cross-device communications (e.g., first and second systems). Each data type may be modelled by HMMs 354, for example using p(X,Z|θ) as defined in Equation 2. The data type determiner 356 determines the data type of data by finding the HMM i with max posterior probability by Equation 3 above. The data categorizer 358 may categorize the data based on the data type.

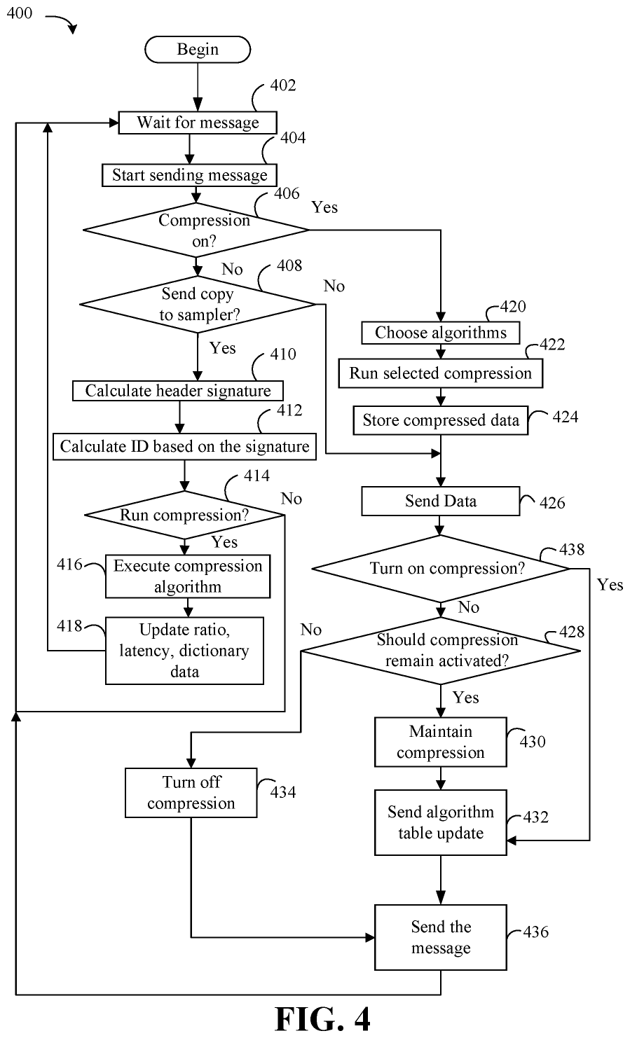

FIG. 4 shows a method 400 of compressing data. The method 400 may be readily combinable with any of the embodiments described herein. For example, the method 400 may implement and/or operate in conjunction with one or more aspects of the compression and decompression architecture 100 (FIG. 1), the method 300 (FIG. 2) and/or the architecture 350 (FIG. 3), already discussed. More particularly, the method 400 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS, TTL technology, or any combination thereof.

Illustrated processing block 402 waits for a message to enable compression which may include data. Thus, processing block 402 checks whether there is any application trying to send data to another device. Illustrated processing block 404 starts sending a message (e.g., to a second computing device). For example, processing block 404 may receive the message from the application at the sending side, and start to send the data to a device associated with the application. Illustrated process 406 determines if compression is currently on. If not, the method 400 may be engaged in a learning process. Therefore, illustrated processing block 408 may determine whether to send a copy of data to a sampler. The sampler may select a subset of the data for learning if so. Illustrated processing block 410 calculates a header signature, for example with the sampler. Illustrated processing block 412 calculates an identification based on the signature. Illustrated processing block 414 determines if compression should be activated for the subset of data. If so, illustrated processing block 416 executes a compression algorithm. Illustrated processing block 418 updates a ratio (e.g., compression ratio), latency and dictionary data for the data. The dictionary data may be the internal data maintained by the compression algorithm. For example, the dictionary data may be the frequency of data samples, keys, or signatures. Such data may be required by the decompressor. The data may be stored in association with the data signature (which may correspond to a category of the data) and the update ratio, latency and dictionary data. If processing block 414 determines that compression should not be activated, the data may not be compressed. In some examples, block 418 further includes determining if a latency parameter of the data and a compression ratio parameter are satisfied by the compression, or if another algorithm may more effectively met the compression ratio and the latency parameter.

If processing block 406 determines that compression is activated, illustrated processing block 420 choses algorithms to compress the data. Illustrated processing 422 runs a selected compression. Illustrated processing blocks 424 stores the compressed data to a destination. Illustrated processing block 426 sends the data. Illustrated processing block 438 determines if compression is to be turned on. If so, illustrated processing block 432 sends an algorithm table to a receiving device (discussed below). Otherwise, illustrated processing block 428 determines if the compression (which is already activated) should remain activated. If so, illustrated processing block 430 maintains the compression and illustrated processing block 432 sends the algorithms table to the destination so that the destination can decompress the data. Illustrated processing block 436 sends the message so that the message send is complete. Otherwise, illustrated processing block 434 turns off the compression. It also bears note that if processing block 408 determines that a copy should not be sent to the sampler, than illustrated processing block 426 may execute without compressing the data.

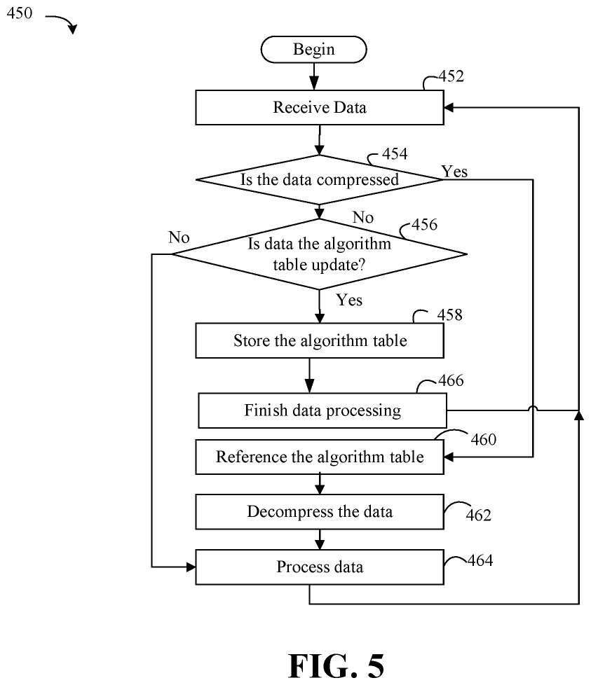

FIG. 5 shows a method 450 of decompressing data. The method 450 may be readily combinable with any of the embodiments described herein. For example, the method 450 may implement and/or operate in conjunction with one or more aspects of the compression and decompression architecture 100 (FIG. 1), the method 300 (FIG. 2) and/or the architecture 350 (FIG. 3) and/or method 400 (FIG. 4). More particularly, the method 450 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS, TTL technology, or any combination thereof.

Illustrated processing block 452 receives data. Illustrated processing block 454 determines if data is compressed. If not, illustrated processing block 456 determines if the data is an algorithm table update. If so, illustrated processing block 458 stores the algorithm table for future reference and illustrated processing block 466 finishes the data processing. Otherwise if the data does not include an algorithm table, illustrated processing block 464 processes the data (e.g., in an uncompressed fashion to avoid decompression).

If processing block 454 determines that the data is compressed, illustrated processing block 460 references the algorithm table to determine a compression algorithm that compressed the data. Illustrated processing block 462 decompresses the data according to the compression algorithm. Illustrated processing block 464 processes the data which is now decompressed.

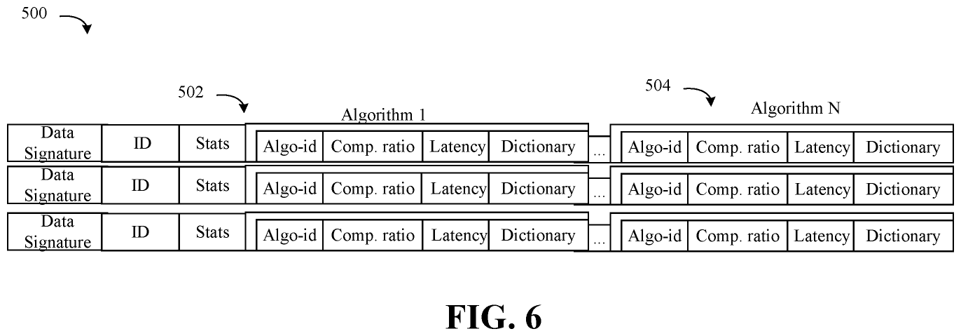

Turning now to FIG. 6, a compression/decompression table 500 is provided. The compression/decompression table 500 includes an algorithm and historical details for the algorithm. For example algorithm 1 502 includes various data signatures, IDs, stats, algorithm ID, compression ratio (comp. ratio), latency and dictionary. Algorithm N 504 includes various data signatures, IDs, stats, algorithm ID, compression ratio (comp. ratio), latency and dictionary.

During compression, data may be added to the compression/decompression table 500 in association with a specific data signature that is unique to the data. The data may be compressed and sent as a packet that includes the data signature. The compression/decompression table 500 may be used (e.g., shared to) by a data decompressor as well to decompress the data. Thus, packets may be decoded based on the data signature in the packet, and with reference to the compression/decompression table 500 using the data signature as a key to identify an algorithm (e.g., 1 or N) that was used to compress the data.

The mapping in the compression/decompression table 500 between data signature and a respective algorithm may not store the historical data points, but stores the statistics of each type of signature only such as the resulting <signature-data, ID, stats, {<algorithm-id, compress-ratio, latency, dictionary}>. Each sampled data will go through a number of modified compression algorithms and calculate their compression ratio. Once compression is turned on, the compressor will communicate the index of pre-set algorithms, and the accumulated compression dictionary, and start to the compression. The decompressor will apply the same set of algorithm and dictionary for decompression.

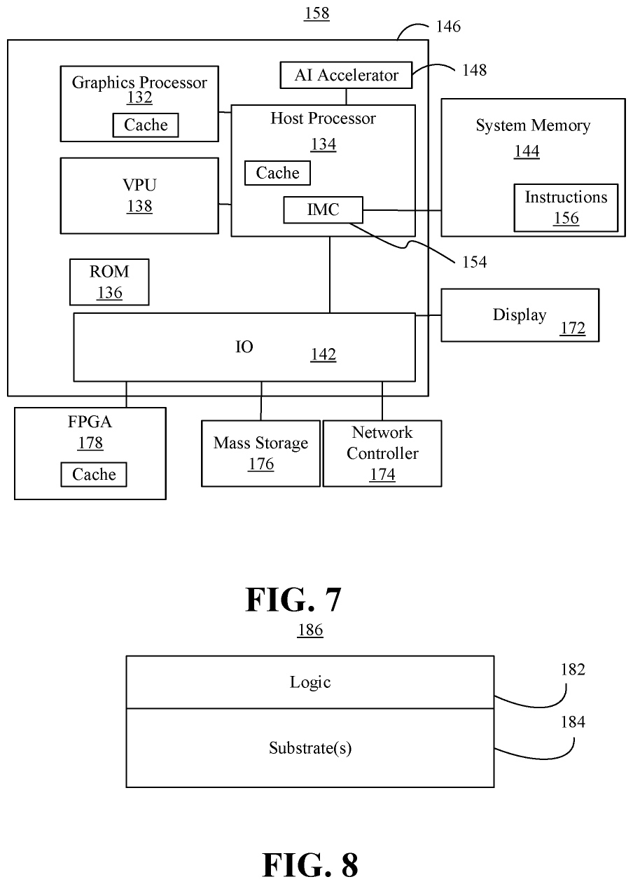

Turning now to FIG. 7, a performance enhanced computing system 158 is shown. The computing system 158 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), etc., or any combination thereof. In the illustrated example, the computing system 158 includes a host processor 134 (e.g., CPU) having an integrated memory controller (IMC) 154 that is coupled to a system memory 144.

The illustrated computing system 158 also includes an input output (IO) module 142 implemented together with the host processor 134, a graphics processor 132 (e.g., GPU), ROM 136, and AI accelerator 148 on a semiconductor die 146 as a system on chip (SoC). The illustrated IO module 142 communicates with, for example, a display 172 (e.g., touch screen, liquid crystal display/LCD, light emitting diode/LED display), a network controller 174 (e.g., wired and/or wireless), FPGA 178 and mass storage 176 (e.g., hard disk drive/HDD, optical disk, solid state drive/SSD, flash memory). Furthermore, the SoC 146 may further include processors (not shown) and/or the AI accelerator 148 dedicated to artificial intelligence (AI) and/or neural network (NN) processing. For example, the system SoC 146 may include a vision processing unit (VPU) 138 and/or other AI/NN-specific processors such as AI accelerator 148, etc.

The graphics processor 132 and/or the host processor 134 may execute instructions 156 retrieved from the system memory 144 (e.g., a dynamic random-access memory) and/or the mass storage 176 to implement aspects as described herein. For example, the graphics processor 132, the host processor 134, AI accelerator 148 and VPU 138 may communicate with each other and/or other devices with compression and decompression schemes as described herein. When the instructions 156 are executed, the computing system 158 may implement one or more aspects of the embodiments described herein. For example, the computing system 158 may implement one or more aspects of the compression and decompression architecture 100 (FIG. 1), the method 300 (FIG. 2) and/or the architecture 350 (FIG. 3), method 400 (FIG. 4) and/or method 450 (FIG. 5) already discussed. The illustrated computing system 158 is therefore considered to be performance-enhanced at least to the extent that it enables the computing system 158 to compress and decompress data in a low latency manner.

FIG. 8 shows a semiconductor apparatus 186 (e.g., chip, die, package). The illustrated apparatus 186 includes one or more substrates 184 (e.g., silicon, sapphire, gallium arsenide) and logic 182 (e.g., transistor array and other integrated circuit/IC components) coupled to the substrate(s) 184. In an embodiment, the apparatus 186 is operated in an application development stage and the logic 182 performs one or more aspects of the embodiments described herein, for example, one or more aspects of the compression and decompression architecture 100 (FIG. 1), the method 300 (FIG. 2) and/or the architecture 350 (FIG. 3), method 400 (FIG. 4) and/or method 450 (FIG. 5) already discussed. The logic 182 may be implemented at least partly in configurable logic or fixed-functionality hardware logic. In one example, the logic 182 includes transistor channel regions that are positioned (e.g., embedded) within the substrate(s) 184. Thus, the interface between the logic 182 and the substrate(s) 184 may not be an abrupt junction. The logic 182 may also be considered to include an epitaxial layer that is grown on an initial wafer of the substrate(s) 184.

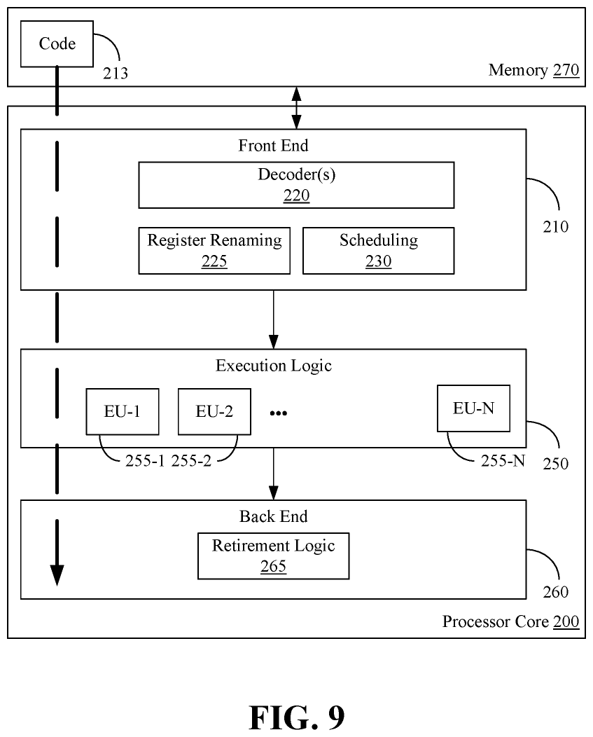

FIG. 9 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 9, a processing element may alternatively include more than one of the processor core 200 illustrated in FIG. 9. The processor core 200 may be a single-threaded core or, for at least one embodiment, the processor core 200 may be multithreaded in that it may include more than one hardware thread context (or “logical processor”) per core.

FIG. 9 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement one or more aspects of the embodiments such as, for example, the compression and decompression architecture 100 (FIG. 1), the method 300 (FIG. 2) and/or the architecture 350 (FIG. 3), method 400 (FIG. 4) and/or method 450 (FIG. 5) already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 9, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

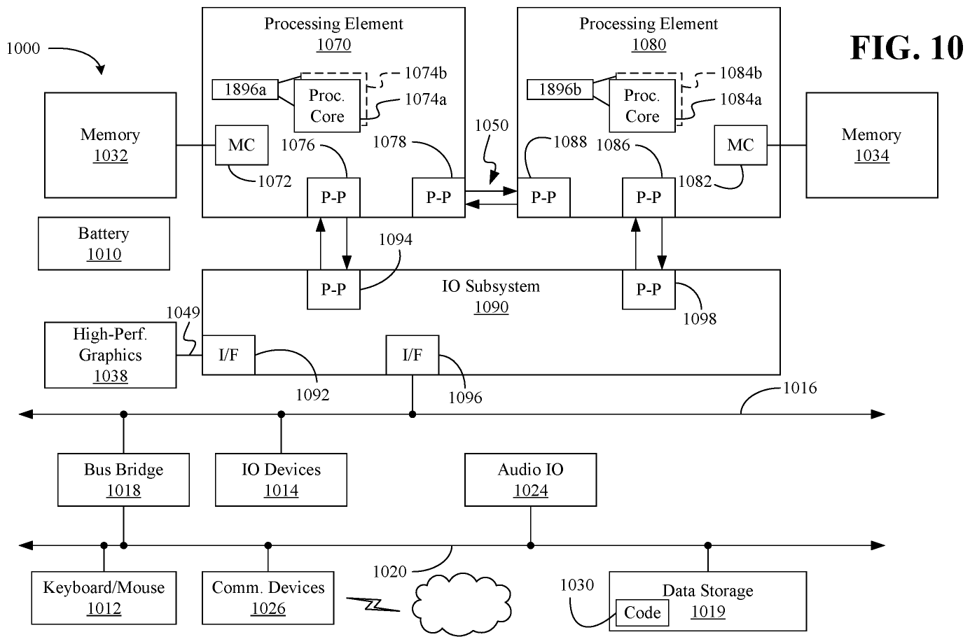

Referring now to FIG. 10, shown is a block diagram of a computing system 1000 embodiment in accordance with an embodiment. Shown in FIG. 10 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 10 may be implemented as a multi-drop bus rather than point-to-point interconnect.

As shown in FIG. 10, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 9.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments is not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 10, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 10, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments is not so limited.

As shown in FIG. 10, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement one or more aspects of the compression and decompression architecture 100 (FIG. 1), the method 300 (FIG. 2) and/or the architecture 350 (FIG. 3), method 400 (FIG. 4) and/or method 450 (FIG. 5) already discussed. Further, an audio I/O 1024 may be coupled to second bus 1020 and a battery 1010 may supply power to the computing system 1000.

Note that other embodiments are contemplated. For example, instead of the point-to-point architecture of FIG. 10, a system may implement a multi-drop bus or another such communication topology. Also, the elements of FIG. 10 may alternatively be partitioned using more or fewer integrated chips than shown in FIG. 10.

### Additional Notes and Examples

Example 1 includes a computing system comprising a processor, and a memory coupled to the processor, the memory including a set of executable program instructions, which when executed by the processor, cause the computing system to identify data that is to be transferred from a first device to a second device, classify the data into a category from a plurality of categories, select a compression scheme from a plurality of compression schemes based on the category, and compress the data based on the compression scheme.

Example 2 includes the computing system of Example 1, wherein the executable program instructions, when executed, cause the computing system to select the compression scheme based on a compression ratio parameter and a latency parameter associated with the category.

Example 3 includes the computing system of any one of Examples 1 to 2, wherein the executable program instructions, when executed, cause the computing system to determine that a hardware limit been reached, and determine that the data is to be compressed based on the hardware limit being reached.

Example 4 includes the computing system of any one of Examples 1 to 3, wherein the executable program instructions, when executed, cause the computing system to classify the data into the category with a Hidden Markov Model.

Example 5 includes the computing system of any one of Examples 1 to 4, wherein the executable program instructions, when executed, cause the computing system to classify the data into the category based on one or more of a packet size distribution associated with the data or a subset of bytes of the data and through one or more of a learning process executed during runtime to classify a plurality of data packets, or through an offline learning process based on pre-selected data packets, and change a compression algorithm during the runtime based on compression efficiency data collected during the runtime.

Example 6 includes the computing system of any one of Examples 1 to 5, wherein the executable program instructions, when executed, cause the computing system to select the compression scheme based on a map of the plurality of categories to compression schemes.

Example 7 includes a semiconductor apparatus comprising one or more substrates, and logic coupled to the one or more substrates, wherein the logic is implemented in one or more of configurable or fixed-functionality hardware, the logic to identify data that is to be transferred from a first device to a second device, classify the data into a category from a plurality of categories, select a compression scheme from a plurality of compression schemes based on the category, and compress the data based on the compression scheme.

Example 8 includes the apparatus of Example 7, wherein the logic coupled to the one or more substrates is to select the compression scheme based on a compression ratio parameter and a latency parameter associated with the category.

Example 9 includes the apparatus of any one of Examples 7 to 8, wherein the logic coupled to the one or more substrates is to determine that a hardware limit been reached, and determine that the data is to be compressed based on the hardware limit being reached.

Example 10 includes the apparatus of any one of Examples 7 to 9, wherein the logic coupled to the one or more substrates is to classify the data into the category with a Hidden Markov Model.

Example 11 includes the apparatus of any one of Examples 7 to 10, wherein the logic coupled to the one or more substrates is to classify the data into the category based on one or more of a packet size distribution associated with the data or a subset of bytes of the data and through one or more of a learning process executed during runtime to classify a plurality of data packets, or through an offline learning process based on pre-selected data packets, and change a compression algorithm during the runtime based on compression efficiency data collected during the runtime.

Example 12 includes the apparatus of any one of Examples 7 to 11, wherein the logic coupled to the one or more substrates is to select the compression scheme based on a map of the plurality of categories to compression schemes.

Example 13 includes the apparatus of any one of Examples 7 to 12, wherein the logic coupled to the one or more substrates includes transistor channel regions that are positioned within the one or more substrates.

Example 14 includes at least one computer readable storage medium comprising a set of executable program instructions, which when executed by a computing system, cause the computing system to identify data that is to be transferred from a first device to a second device, classify the data into a category from a plurality of categories, select a compression scheme from a plurality of compression schemes based on the category, and compress the data based on the compression scheme.

Example 15 includes the at least one computer readable storage medium of Example 14, wherein the instructions, when executed, further cause the computing system to select the compression scheme based on a compression ratio parameter and a latency parameter associated with the category.

Example 16 includes the at least one computer readable storage medium of any one of Examples 14 to 15, wherein the instructions, when executed, further cause the computing system to determine that a hardware limit been reached, and determine that the data is to be compressed based on the hardware limit being reached.

Example 17 includes the at least one computer readable storage medium of any one of Examples 14 to 16, wherein the instructions, when executed, further cause the computing system to classify the data into the category with a Hidden Markov Model.

Example 18 includes the at least one computer readable storage medium of any one of Examples 14 to 17, wherein the instructions, when executed, further cause the computing system to classify the data into the category based on one or more of a packet size distribution associated with the data or a subset of bytes of the data and through one or more of a learning process executed during runtime to classify a plurality of data packets, or through an offline learning process based on pre-selected data packets, and change a compression algorithm during the runtime based on compression efficiency data collected during the runtime.

Example 19 includes the at least one computer readable storage medium of any one of Examples 14 to 18, wherein the instructions, when executed, further cause the computing system to select the compression scheme based on a map of the plurality of categories to compression schemes.

Example 20 includes a method comprising identifying data that will be transferred from a first device to a second device, classifying the data into a category from a plurality of categories, selecting a compression scheme from a plurality of compression schemes based on the category, and compressing the data based on the compression scheme.

Example 21 includes the method of Example 20, further comprising selecting the compression scheme based on a compression ratio parameter and a latency parameter associated with the category.

Example 22 includes the method of any one of Examples 20 to 21 further comprising determining that a hardware limit been reached, and determining that the data will be compressed based on the hardware limit being reached.

Example 23 includes the method of any one of Examples 20 to 22, further comprising classifying the data into the category with a Hidden Markov Model.

Example 24 includes the method any one of Examples 20 to 23, further comprising classifying the data into the category based on one or more of a packet size distribution associated with the data or a subset of bytes of the data and through one or more of a learning process executed during runtime to classify a plurality of data packets, or through an offline learning process based on pre-selected data packets, and changing a compression algorithm during the runtime based on compression efficiency data collected during the runtime.

Example 25 includes the method of any one of Examples 20 to 24, further comprising selecting the compression scheme based on a map of the plurality of categories to compression schemes.

Example 26 includes a semiconductor apparatus comprising means for identifying data that will be transferred from a first device to a second device, means for classifying the data into a category from a plurality of categories, means for selecting a compression scheme from a plurality of compression schemes based on the category, and means for compressing the data based on the compression scheme.

Example 27 includes the semiconductor apparatus of Example 26, further comprising means for selecting the compression scheme based on a compression ratio parameter and a latency parameter associated with the category.

Example 28 includes the semiconductor apparatus of any one of Examples 26 to 27, further comprising means for determining that a hardware limit been reached, and means for determining that the data will be compressed based on the hardware limit being reached.

Example 29 includes the semiconductor apparatus any one of Examples 26 to 28, further comprising means for classifying the data into the category with a Hidden Markov Model.

Example 30 includes the semiconductor apparatus of Example any one of Example 26 to 29, further comprising means for classifying the data into the category based on one or more of a packet size distribution associated with the data or a subset of bytes of the data and through one or more of a learning process executed during runtime to classify a plurality of data packets, or through an offline learning process based on pre-selected data packets, and means for changing a compression algorithm during the runtime based on compression efficiency data collected during the runtime.

Example 31 includes the semiconductor apparatus of any one of Examples 26 to 30, further comprising means for selecting the compression scheme based on a map of the plurality of categories to compression schemes.

Example 32 includes the computing system of any one of Examples 1 to 6, wherein the executable program instructions, when executed, cause the computing system to receive a compression table associated with the compression schemes, store the compression table as a decompression table, reference the decompression table to identify an algorithm from the decompression table that was used to compress the data, and decompress the data based on the algorithm.

Example 33 includes the computing system of Example 32, wherein the executable program instructions, when executed, cause the computing system to determine an algorithm index from the data, and identify the algorithm based on the algorithm index.

Example 34 includes the apparatus of any one of Examples 7 to 13, wherein the logic coupled to the one or more substrates is to receive a compression table associated with the compression schemes, store the compression table as a decompression table, reference the decompression table to identify an algorithm from the decompression table that was used to compress the data, and decompress the data based on the algorithm.

Example 35 includes the apparatus of Example 34, wherein the logic coupled to the one or more substrates is to determine an algorithm index from the data, and identify the algorithm based on the algorithm index.

Example 36 includes the at least one computer readable storage medium of any one of Examples 14 to 19, wherein the instructions, when executed, further cause the computing system to receive a compression table associated with the compression schemes, store the compression table as a decompression table, reference the decompression table to identify an algorithm from the decompression table that was used to compress the data, and decompress the data based on the algorithm.

Example 37 includes the at least one computer readable storage medium of Example 36, wherein the instructions, when executed, further cause the computing system to determine an algorithm index from the data, and identify the algorithm based on the algorithm index.

Example 38 includes the method of any one of Examples 20 to 25, further comprising receiving a compression table associated with the compression schemes, storing the compression table as a decompression table, referencing the decompression table to identify an algorithm from the decompression table that was used to compress the data, and decompressing the data based on the algorithm.

Example 39 includes the method of Example 38, further comprising determining an algorithm index from the data, and identify the algorithm based on the algorithm index.

Example 40 includes the apparatus of any one of Examples 26 to 31, further comprising means for receiving a compression table associated with the compression schemes, means for storing the compression table as a decompression table, means for referencing the decompression table to identify an algorithm from the decompression table that was used to compress the data, and means for decompressing the data based on the algorithm.

Example 41 includes the apparatus of Example 40, further comprising means for determining an algorithm index from the data, and means for identifying the algorithm based on the algorithm index.

Thus, technology described herein may provide for an enhanced system that enables selective compression and decompression when desired. Doing so may significantly reduce the latency of operations that may otherwise occur when hardware limits are reached. Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines. Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a processor; and
a memory coupled to the processor, the memory including a set of executable program instructions, which when executed by the processor, cause the computing system to:
identify data that is to be transferred from a first device to a second device;
classify the data into a category from a plurality of categories;
select a compression scheme from a plurality of compression schemes based on the category; and
compress the data based on the compression scheme.

2. The computing system of claim 1, wherein the executable program instructions, when executed, cause the computing system to:
select the compression scheme based on a compression ratio parameter and a latency parameter associated with the category.

3. The computing system of claim 1, wherein the executable program instructions, when executed, cause the computing system to:
determine that a hardware limit been reached; and
determine that the data is to be compressed based on the hardware limit being reached.

4. The computing system of claim 1, wherein the executable program instructions, when executed, cause the computing system to:
classify the data into the category with a Hidden Markov Model.

5. The computing system of claim 1, wherein the executable program instructions, when executed, cause the computing system to:
classify the data into the category based on one or more of a packet size distribution associated with the data or a subset of bytes of the data and through one or more of a learning process executed during runtime to classify a plurality of data packets, or through an offline learning process based on pre-selected data packets; and
change a compression algorithm during the runtime based on compression efficiency data collected during the runtime.

6. The computing system of claim 1, wherein the executable program instructions, when executed, cause the computing system to:
select the compression scheme based on a map of the plurality of categories to compression schemes.

7. A semiconductor apparatus comprising:
one or more substrates; and
logic coupled to the one or more substrates, wherein the logic is implemented in one or more of configurable or fixed-functionality hardware, the logic to:
identify data that is to be transferred from a first device to a second device,
classify the data into a category from a plurality of categories;
select a compression scheme from a plurality of compression schemes based on the category; and
compress the data based on the compression scheme.

8. The apparatus of claim 7, wherein the logic coupled to the one or more substrates is to:
select the compression scheme based on a compression ratio parameter and a latency parameter associated with the category.

9. The apparatus of claim 7, wherein the logic coupled to the one or more substrates is to:
determine that a hardware limit been reached; and
determine that the data is to be compressed based on the hardware limit being reached.

10. The apparatus of claim 7, wherein the logic coupled to the one or more substrates is to:
classify the data into the category with a Hidden Markov Model.

11. The apparatus of claim 7, wherein the logic coupled to the one or more substrates is to:
classify the data into the category based on one or more of a packet size distribution associated with the data or a subset of bytes of the data and through one or more of a learning process executed during runtime to classify a plurality of data packets, or through an offline learning process based on pre-selected data packets; and
change a compression algorithm during the runtime based on compression efficiency data collected during the runtime.

12. The apparatus of claim 7, wherein the logic coupled to the one or more substrates is to:
select the compression scheme based on a map of the plurality of categories to compression schemes.

13. The apparatus of claim 7, wherein the logic coupled to the one or more substrates includes transistor channel regions that are positioned within the one or more substrates.

14. At least one computer readable storage medium comprising a set of executable program instructions, which when executed by a computing system, cause the computing system to:
identify data that is to be transferred from a first device to a second device,
classify the data into a category from a plurality of categories;
select a compression scheme from a plurality of compression schemes based on the category; and
compress the data based on the compression scheme.

15. The at least one computer readable storage medium of claim 14, wherein the instructions, when executed, further cause the computing system to:
select the compression scheme based on a compression ratio parameter and a latency parameter associated with the category.

16. The at least one computer readable storage medium of claim 14, wherein the instructions, when executed, further cause the computing system to:
determine that a hardware limit been reached; and
determine that the data is to be compressed based on the hardware limit being reached.

17. The at least one computer readable storage medium of claim 14, wherein the instructions, when executed, further cause the computing system to:
classify the data into the category with a Hidden Markov Model.

18. The at least one computer readable storage medium of claim 14, wherein the instructions, when executed, further cause the computing system to:
classify the data into the category based on one or more of a packet size distribution associated with the data or a subset of bytes of the data and through one or more of a learning process executed during runtime to classify a plurality of data packets, or through an offline learning process based on pre-selected data packets; and
change a compression algorithm during the runtime based on compression efficiency data collected during the runtime.

19. The at least one computer readable storage medium of claim 14, wherein the instructions, when executed, further cause the computing system to:
select the compression scheme based on a map of the plurality of categories to compression schemes.

20. A method comprising:
identifying data that will be transferred from a first device to a second device,
classifying the data into a category from a plurality of categories;
selecting a compression scheme from a plurality of compression schemes based on the category; and
compressing the data based on the compression scheme.

21. The method of claim 20, further comprising:
selecting the compression scheme based on a compression ratio parameter and a latency parameter associated with the category.

22. The method of claim 20, further comprising:
determining that a hardware limit been reached; and
determining that the data will be compressed based on the hardware limit being reached.

23. The method of claim 20, further comprising:
classifying the data into the category with a Hidden Markov Model.

24. The method of claim 20, further comprising:
classifying the data into the category based on one or more of a packet size distribution associated with the data or a subset of bytes of the data and through one or more of a learning process executed during runtime to classify a plurality of data packets, or through an offline learning process based on pre-selected data packets; and
changing a compression algorithm during the runtime based on compression efficiency data collected during the runtime.

25. The method of claim 20, further comprising:
selecting the compression scheme based on a map of the plurality of categories to compression schemes.
